(19) United States
(12) Patent Application Publication
(10) Pub. No.: US 2017/0192405 A1
(43) Pub. Date: Jul. 6, 2017

(54) CONDITION MONITORING DEVICE AND MONITORING SYSTEM USING THE SAME

(71) Applicant: ABB Schweiz AG, Baden (CH)

(72) Inventors: Maciej Orman, Shanghai (CN); Pawel Rzeszucinski, Kedzierzyn-Kozle (PL); Daniel Lewandowski, Krakow (PL); Markus Aleksy, Ludwigshafen (DE); Nicolaie Laurentiu Fantana, Heidelberg (DE)

(21) Appl. No.: 15/257,272

(22) Filed: Sep. 6, 2016

Related U.S. Application Data
(63) Continuation of application No. PCT/EP2015/054535, filed on Mar. 4, 2015.

(30) Foreign Application Priority Data
Nov. 12, 2014 (CN) 201410645274.6

(51) Int. Cl. G05B 19/048; G01M 13/00

(52) U.S. Cl. CPC G05B 19/048; G01M 13/00

(57) ABSTRACT

A condition monitoring device and monitoring system in one form includes an enclosure being shaped into a form of a portable tool for daily use, including a part for performing daily use functionality and being adapted to be carried by a user; and at least one sensor block being housed in the enclosure, being adapted for measuring data produced by a machine. The condition monitory device can be included in a system of multiple devices. The enclosure can take many forms including but not limited to a writing element, a memory unit (such as but not limited to a memory stick), and a screwdriver. The device can include a sensor block and a communication block. In some forms the device can be a mobile phone. The device can be included in a system that includes a server for processing signals, and/or a portable device that includes a processor.

### TECHNICAL FIELD

The invention relates to condition monitoring device and monitoring system using the same, and more particularly to condition monitoring device for electrical machine and the monitoring system using the same.

### BACKGROUND ART

Patent US 20070200722 A1 discloses a condition monitoring system that has a portable diagnostic sensor e.g. vibration sensor, for measuring a machinery vibration signal e.g. acceleration, for machinery e.g. motor, to be inspected. A limited-range diagnostic sensor communication link e.g. wire, is used for communicating the signal. The sensor is combined with a radio frequency information system communicator, where the signal comprises equipment identification information from the communicator. A portable data processor is housed in an enclosure for receiving the signal from the sensor over the link. This system is disadvantageous in that it does not provide a way in which the portable diagnostic sensor can be integrated into a tool for daily use, such as a pen, a memory stick or a screwdriver, so that the user can carry this portable diagnostic sensor always with him as he will carry a tool for daily use.

Patent WO 2013175162 A1 discloses a condition monitoring device that has a micro-electro-mechanical system sensor e.g. accelerometer, for monitoring a parameter i.e. vibration, of a machine e.g. rotating machine. A central processor is connected to the sensor for analyzing recorded signals. A wireless transmitter and a wireless receiver are connected to the processor for allowing external communication. A battery is connected to the processor. A visual indicator i.e. set of LEDs, is arranged to indicate status of the monitored machine based upon the sensed parameter. This condition monitoring device also has a drawback of not being able of integration into a tool for daily use as described above. In addition, different users may wish to incorporate different types of sensors in the condition monitoring device, depending on the actual application. Accordingly, the condition monitoring device must be versatile to satisfy the needs of many users. As a result, when only one type of the condition monitoring device is manufactured, the condition monitoring device should incorporate a high number of different types of sensors, which is often impractical. As a result, the condition monitoring device often incorporates a sensor that is useful for one user but not for another user. For a user purchasing a condition monitoring device, an undesirable sensor would raise the initial purchasing cost of the condition monitoring device. Further, such an undesirable sensor would add to the weight of the condition monitoring device, its power consumption and decrease the data acquisition capabilities, eventually obstructing miniaturization of the condition monitoring device.

### BRIEF SUMMARY OF THE INVENTION

It is therefore an objective of the embodiments of the present invention to at least partly solve or reduce the problems in the art.

According to an aspect of the present invention, it provides a condition monitoring device, including: an enclosure being shaped into a form of a portable tool for daily use, including a part for performing daily use functionality and being adapted to be carried by a user; and at least one sensor block being housed in the enclosure, being adapted for measuring data produced by a machine.

According to another aspect of present invention, it provides a monitoring system including the condition monitoring device, wherein: the condition monitoring device further includes a communication block for communicating a first signal representing the measured data by the at least one sensor block of the condition monitoring device; the monitoring system further includes: a portable device including a processor being adapted for post processing the first signal representing the measured data communicated by the communication block of the condition monitoring device.

According to another aspect of present invention, it provides a condition monitoring apparatus including: a first condition monitoring device and a second condition monitoring device; wherein: the enclosure of the first condition monitoring device includes an connection structure detachably attachable to the second condition monitoring device; and the second condition monitoring device includes a connector mateable with the connection structure of the first condition monitoring device.

According to another aspect of present invention, it provides a monitoring system including the condition monitoring device, wherein: the condition monitoring device further includes a communication block for communicating a first signal representing the measured data by the at least one sensor block of the condition monitoring device; the monitoring system further includes: a server including a processor being adapted for processing the first signal representing the measured data communicated by the communication block of the condition monitoring device.

By having such configuration of the condition monitoring device, the user can carry the condition monitoring device always with them as they will carry a normal portable tool for daily use while does not need to carry two separate units like a condition monitoring system and a portable tool for daily use. This makes the user daily life more convenient. This also determines that a practical implementation of the enclosure in the shape of portable tool for daily use must be of relatively small size, low weight and low cost.

Further embodiments, aspects, details and advantages are furthermore evident from the dependent claims, the description, and the drawings.

### BRIEF DESCRIPTION OF THE DRAWINGS

The subject matter of the invention will be explained in more detail in the following text with reference to preferred exemplary embodiments which are illustrated in the drawings, in which:

FIG. 1 shows a condition monitoring device according to an embodiment of present invention;

FIG. 2 shows a condition monitoring system using the condition monitoring device according to an embodiment of present invention; and

FIG. 3 shows a condition monitoring apparatus according to an embodiment of present invention.

The reference symbols used in the drawings, and their meanings, are listed in summary form in the list of reference symbols. In principle, identical parts are provided with the same reference symbols in the figures.

### PREFERRED EMBODIMENTS OF THE INVENTION

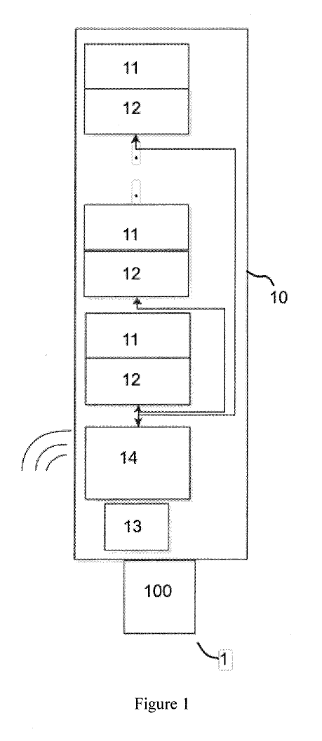

FIG. 1 shows a condition monitoring device according to an embodiment of present invention. As shown in FIG. 1, the condition monitoring device 1 includes an enclosure 10 shaped like a portable tool for daily use and at least one sensor block 11. The enclosure 10 is shaped into a form of a portable tool for daily use, for example a pen, a memory stick, or a screwdriver, etc. The enclosure 10 includes a part for performing daily use functionality, for example, a writing element 100 for applying ink to a surface external to the condition monitoring device where the enclosure 10 is pen-shaped and can be carried by the user like carrying a normal pen. The enclosure would include a memory unit for storing data in the enclosure where the enclosure is memory stick-shaped and can be carried by the user like carrying a normal memory stick, or a screwdriver shaft for turning screws where the enclosure is screw driver-shaped and can be carried by the user like carrying a normal screwdriver, etc. The sensor block 11 can measure data produced by a machine. The sensor can be an accelerometer, a magnetometer, a microphone, a mini infrared camera, a temperature sensor etc, or a different compilation of these sensors for different applications. The sensor block 11 can be housed in the enclosure 10. By having such configuration of the condition monitoring device, the user can carry the condition monitoring device always with them as they will carry a normal portable tool for daily use while does not need to carry two separate units like a condition monitoring system and a portable tool for daily use. This makes the user daily life more convenient. This also determines that a practical implementation of the enclosure in the shape of portable tool for daily use must be of relatively small size, low weight and low cost.

The condition monitoring device 1 can further include at least one analog-digital converter 12, a power supply block 13, and a communication block 14, all of which can be housed in the enclosure 10. The at least one analog-digital converter 12 can convert analog signal output from the respective sensor block 11 into digital signal, which represents the measured data samples of the data produced by the monitored machine. The communication block 14 can further transmit the digital signal from the analog-digital converter 12 to a portable device or a server via a connection, either of wireless or wired for performing data processing of the measured quantities. The power block 13 can supply power to the sensor block 11, the analog-digital converter 12, and the communication block 14.

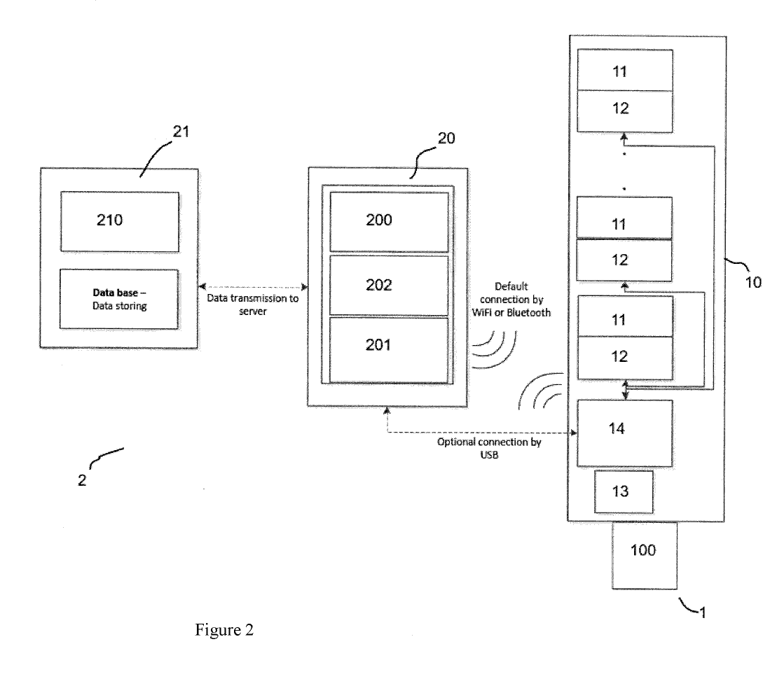

FIG. 2 shows a monitoring system using the condition monitoring device according to an embodiment of present invention. As shown in FIG. 2, the monitoring system 2 includes the condition monitoring device 1 and a portable device 20. The communication block 14 of the condition monitoring device 1 can communicate to the portable device 20 a first signal representing the measured data by the at least one sensor block 11 of the condition monitoring device 1. The portable device 20 can be a mobile phone which includes a processor 200 being adapted for post processing the first signal representing the measured data communicated by the communication block 14 of the condition monitoring device 1.

The portable device 20 can further include at least one sensing device 201 for measuring the data produced by the monitored machine simultaneously with the at least one sensor block 11 of the condition monitoring device 1. For example, contemporary mobile phones are typically equipped with microphones, magnetic field sensors, accelerometers and many other sensing device types. This fact can be exploited to provide additional measurements, possibly recorded simultaneously together with sensor block 11 embedded in the condition monitoring device 1. The processor 200 of the portable device 20 is further adapted for post processing a second signal representing the measured data from the at least one sensing device 201 and analysing the first signal and the second signal in combination. Using information from both the condition monitoring device 1 as well as the sensing devices 201 of the portable device 20 enables diagnosing potential machinery faults with higher confidence by using many different analysis types.

The monitoring system 2 can further include a server 21. If the portable device's computation power is not high enough for performing the data processing, the data representing the outcome of the post processing by the portable device 20 can be transmitted to the server 21 for advanced data processing. In particular, the portable device 20 further includes a transmitter 202 for transmitting a third signal representing result from the post processing by its processer 201. The processor 210 of the server 21 can perform advance processing the third signal transmitted from the transmitter 202 of the portable device 20.

As an alternative, the portable device 20 can be omitted in the monitoring system 2. In particular, the communication block 14 of the condition monitoring device 1 can communicate the first signal representing the measured data by the at least one sensor block 11 of the condition monitoring device 1 to the server 21. The processor 210 of the server can process the first signal representing the measured data communicated by the communication block 14 of the condition monitoring device 1.

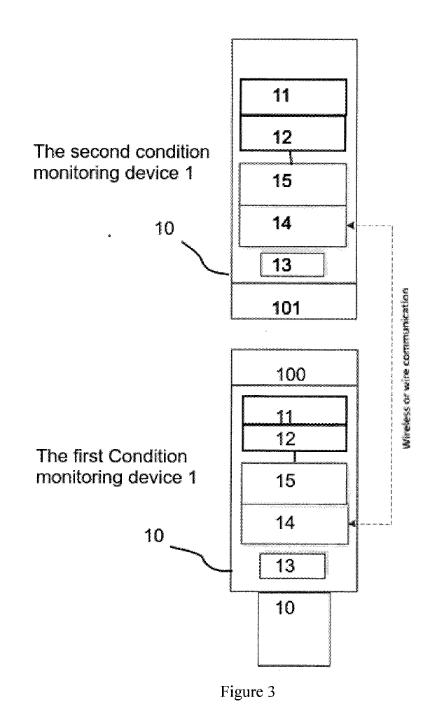

FIG. 3 shows a condition monitoring apparatus according to an embodiment of present invention. As shown in FIG. 3, the condition monitoring apparatus 3 (3 not shown in figures) includes a first condition monitoring device 1 according to FIG. 1 and a second monitoring device 1 according to FIG. 1. The enclosure 10 of the first condition monitoring device 1 includes a connection structure detachably attachable to the second condition monitoring device; and the second condition monitoring device includes a connector mateable with the connection structure of the first condition monitoring device. For example, the connection structure can be formed by a recess such as a female connector 100. The connector can be formed by a projection such as a male connector 101. The second monitoring device 1 is detachably attached to the first monitoring device 1 by fitting the male connector 101 to the female connector 101. Thus, from the condition monitoring devices with plural types of sensor blocks and with a female connector mated with the male connector 100 and 101, the user selects the sensor blocks associated with the condition the user wishes to monitor. Then, the user attaches the selected condition monitoring devices with the female connector and the male connector so that the condition monitoring apparatus 3 acquires the data representing the state detected by the sensor blocks. Therefore, the user can select the necessary sensor blocks and connect the selected sensor blocks. This is economical. The measured data acquisition process is triggered at same time for all the sensor blocks 11, however the acquired measured data are stored for each sensor block 11 separately within dedicated storage block 15. When recording is finished, data are transferred from the dedicated storage block 15 to mobile phone for data processing. Optionally the data from each storage block 15 can be transferred directly to the server for advanced data processing.

Though the present invention has been described on the basis of some preferred embodiments, those skilled in the art should appreciate that those embodiments should by no way limit the scope of the present invention. Without departing from the spirit and concept of the present invention, any variations and modifications to the embodiments should be within the apprehension of those with ordinary knowledge and skills in the art, and therefore fall in the scope of the present invention which is defined by the accompanied claims.

1-12. (canceled)

13. A condition monitoring device, including:
an enclosure being shaped into a form of a portable tool for daily use, including a part for performing daily use functionality and being adapted to be carried by a user; and
at least one sensor block being housed in the enclosure and being adapted for measuring data produced by a machine.

14. The condition monitoring device according to claim 13, wherein:
the part of the enclosure is a writing element for applying ink to a surface external to the condition monitoring device;
wherein:
the enclosure is pen-shaped, which can be carried by the user like carrying a pen.

15. The condition monitoring device according to claim 13, wherein:
the part of the enclosure is a memory unit for storing data in the enclosure;
wherein:
the enclosure is memory stick-shaped, which can be carried by the user like carrying a memory stick.

16. The condition monitoring device according to claim 13, wherein:
the part of the enclosure is a screwdriver shaft for turning screws;
wherein:
the enclosure is screwdriver-shaped, which can be carried by the user like carrying a screwdriver.

17. The condition monitoring device according to claim 13, wherein:
the at least one sensor block includes an accelerometer, magnetometer, microphone, infrared camera, or temperature sensor.

18. The condition monitoring device according to claim 13, further including:
a power block, being adapted for supply power to the at least one sensor block.

19. The condition monitoring device of claim 13, which further includes:
a first condition monitoring device that includes the enclosure and the at least one sensor block; and
a second condition monitoring device that includes another enclosure and another of the at least one sensor block;
wherein:
the enclosure of the first condition monitoring device includes a connection structure detachably attachable to the second condition monitoring device; and
the second condition monitoring device includes a connector mateable with the connection structure of the first condition monitoring device.

20. The condition monitoring device of claim 19, wherein:
the part of the enclosure includes one or more of the following:
a writing element for applying ink to a surface external to the condition monitoring device;
a memory unit for storing data in the enclosure; and
a screwdriver shaft for turning screws;

21. The condition monitoring device of claim 19, wherein:
the at least one sensor block includes an accelerometer, magnetometer, microphone, infrared camera, or temperature sensor, and which further includes a power block, being adapted for supply power to the at least one sensor block.

22. A system, comprising:
a condition monitoring device that includes:
an enclosure being shaped into a form of a portable tool for daily use, including a part for performing daily use functionality and being adapted to be carried by a user;
at least one sensor block being housed in the enclosure and being adapted for measuring data produced by a machine; and
a communication block for communicating a first signal representing the measured data by the at least one sensor block of the condition monitoring device; and
a portable device including a processor being adapted for post processing the first signal representing the measured data communicated by the communication block of the condition monitoring device.

23. The system according to claim 22, wherein:
the portable device further includes at least one sensing device for measuring the data produced by the machine simultaneously with the at least one sensor of the condition monitoring device; and
the processor of the portable device is further adapted for post processing a second signal representing the measured data from the at least one sensing device and analyzing the first signal and the second signal in combination.

24. The system according to claim 23, wherein:
the portable device is a mobile phone; and
the at least one sensing device includes a microphone, a magnetic field sensor, or an accelerometer.

25. The system according to claim 23, wherein:
the portable device further includes a transmitter for transmitting a third signal representing the result from the post processing by its processor;
the monitoring system further includes:
a server, being adapted for advance processing the third signal transmitted from the transmitter of the portable device.

26. A system, comprising:
a condition monitoring device that includes:
an enclosure being shaped into a form of a portable tool for daily use, including a part for performing daily use functionality and being adapted to be carried by a user;
at least one sensor block being housed in the enclosure and being adapted for measuring data produced by a machine; and
a communication block for communicating a first signal representing the measured data by the at least one sensor block of the condition monitoring device; and
a server including a processor being adapted for processing the first signal representing the measured data communicated by the communication block of the condition monitoring device.

27. The condition monitoring device of claim 26, wherein:
the part of the enclosure is includes one or more of the following:
a writing element for applying ink to a surface external to the condition monitoring device;
a memory unit for storing data in the enclosure; and
a screwdriver shaft for turning screws;

28. The condition monitoring device of claim 26, wherein:
the at least one sensor block includes an accelerometer, magnetometer, microphone, infrared camera, or temperature sensor, and which further includes a power block, being adapted for supply power to the at least one sensor block.
